(19) United States
(12) Patent Application Publication
(10) Pub. No.: US 2022/0275999 A1
(43) Pub. Date: Sep. 1, 2022

(54) REFRIGERATION AND/OR LIQUEFACTION METHOD, DEVICE AND SYSTEM

(71) Applicant: L'Air Liquide, Societe Anonyme pour l'Etude et l'Exploitation des Procedes Georges Claude, Paris (FR)

(72) Inventors: Fabien DURAND, Sassenage (FR); Damien GUILLET, Sassenage (FR); Remi NICOLAS, Sassenage (FR); Cecile GONDRAND, Sassenage (FR); Jean-Marc BERNHARDT, Sassenage (FR)

(73) Assignee: L'Air Liquide, Societe Anonyme pour l'Etude et l'Exploitation des Procedes Georges Claude, Paris (FR)

(21) Appl. No.: 17/632,978

(22) PCT Filed: Jun. 23, 2020
(86) PCT No.: PCT/EP2020/067417

§ 371 Date: Feb. 4, 2022

(30) Foreign Application Priority Data
Aug. 5, 2019 (FR) FR 1908945

(51) Int. Cl. F25J 1/00; F25B 1/053; F25B 1/10; F25B 11/04; F25B 49/02; F25J 1/02

(52) U.S. Cl. CPC F25J 1/0067; F25B 1/053; F25B 1/10; F25B 11/04; F25B 49/022; F25J 1/005; F25J 1/0065; F25J 1/0072; F25J 1/0204; F25J 1/0248; F25J 1/0298; F25B 2400/14; F25B 2500/09; F25B 2600/022; F25B 2600/0251; F25B 2600/0253; F25J 2205/20; F25J 2220/66; F25J 2230/22; F25J 2280/20; F25J 2280/40

(57) ABSTRACT

Disclosed is a refrigeration and/or liquefaction method using a system that includes a low-temperature refrigeration device comprising a working circuit which forms a loop and contains a working fluid, the working circuit forming a cycle comprising, connected in series: a compression mechanism, a cooling mechanism, an expansion mechanism and a heating mechanism the refrigeration device further comprising a cooling exchanger for extracting heat from the useful fluid stream by exchanging heat with the working fluid flowing in the working circuit, the system comprising a pipe through which the useful fluid stream flows in the cooling exchanger, the method comprising a cooling step in which the refrigeration device is in a first operating mode for cooling the cooling exchanger while a useful fluid stream flows in the cooling exchanger, the method comprising, after said cooling step, a step of cleaning impurities that have solidified in the cooling exchanger, characterized in that during the cleaning step, the refrigeration device is in a second operating mode in which the working gas flows in the working circuit but in which the cooling exchanger cools less intensely than in the first operating mode.

### CROSS-REFERENCE TO RELATED APPLICATIONS

This application is a § 371 of International PCT Application PCT/EP2020/067417, filed Jun. 23, 2020, which claims § 119(a) foreign priority to French patent application FR 1908945, filed Aug. 5, 2019.

### BACKGROUND

### Field of the Invention

The invention relates to a method, a device and a system for refrigeration and/or liquefaction.

The invention relates more particularly to a method for refrigeration and/or liquefaction of a flow of user fluid, in particular natural gas, the method using a cooling and/or liquefaction system comprising a low-temperature refrigeration device, that is to say for refrigeration at a temperature of between minus 100 degrees centigrade and minus 273 degrees centigrade, and in particular between minus 100 degrees centigrade and minus 253 degrees centigrade, the refrigeration device comprising a working circuit forming a loop and containing a working fluid, the working circuit forming a cycle that comprises, in series: a mechanism for compressing the working fluid, a mechanism for cooling the working fluid, a mechanism for expanding the working fluid, and a mechanism for heating the working fluid, the refrigeration device comprising a cooling exchanger intended to extract heat from the flow of user fluid by heat exchange with the working fluid circulating in the working circuit, the system comprising a duct for the circulation of said flow of user fluid in the cooling exchanger, the method comprising a cooling step in which the refrigeration device is in a first cooling operating mode of the cooling exchanger while a flow of user fluid is made to circulate in this cooling exchanger, the method comprising, after this cooling step, a step of cleaning away solidified impurities in the cooling exchanger.

The invention relates in particular to cryogenic refrigerators or liquefiers, for example of the type having a “Turbo Brayton” cycle or “Turbo Brayton coolers” in which a cycle gas (helium, nitrogen, hydrogen or another pure gas or a mixture) undergoes a thermodynamic cycle producing cold which can be transferred to a member or a gas intended to be cooled.

### Related Art

These devices are used in a wide variety of applications and in particular for cooling the natural gas in a tank (for example in ships). The liquefied natural gas is for example subcooled to avoid vaporization thereof or the gaseous part is cooled in order to be reliquefied.

For example, a flow of natural gas can be made to circulate in a heat exchanger cooled by the cycle gas of the refrigerator/liquefier.

The gas cooled in this exchanger may contain impurities (such as carbon dioxide), which are likely to solidify at the cold temperatures achieved at the exchanger. This can block the heat exchanger and impair the efficiency of the system.

One solution may consist in actively heating the heat exchanger with an electric heater. This is costly in terms of energy, however, and often unsuitable for explosive atmospheres.

### SUMMARY OF THE INVENTION

An aim of the present invention is to overcome all or some of the drawbacks of the prior art that are set out above.

To this end, the method according to the invention, which is otherwise in accordance with the generic definition thereof given in the above preamble, is essentially characterized in that, during the cleaning step, the refrigeration device is in a second operating mode in which the working gas circulates in the working circuit but in which the cooling of the cooling exchanger is decreased compared with the first operating mode.

Furthermore, embodiments of the invention may include one or more of the following features:
during the cleaning step, the refrigeration device effects zero cooling or effects heating of the cooling exchanger,
during the cleaning step, a flow of user fluid is made to circulate in the cooling exchanger and is heated by the latter,
the compression mechanism comprises one or more compressors and at least one drive motor for rotating the compressor(s), the refrigeration capacity of the refrigeration device being variable and controlled by regulating the speed of rotation of the drive motor(s), and in that, in the second operating mode, the speed of rotation of at least one of the drive motors is between 1% and 60%, and preferably between 10 and 50%, in particular between 20 and 30%, of the maximum or nominal speed of rotation of said motor,
the compression mechanism comprises a plurality of rotary compressors and at least two drive motors that each comprise a rotary drive shaft, the compressors being driven in rotation by the respective rotary shaft(s), the mechanism for expanding the working fluid comprising at least one rotary turbine that rotates conjointly with a shaft of one of the drive motors of at least one compressor,
in the second operating mode of the refrigeration device, at least one motor comprising a turbine that rotates conjointly with its shaft is stopped, and at least one other drive motor of a compressor operates with a speed of rotation of between 1% and 60%, and preferably between 10 and 50%, in particular between 20 and 30%, of the maximum or nominal speed of said motor,
the at least one stopped motor is braked, meaning that the rotation of the corresponding shaft and/or compressor and/or turbine is braked or prevented,
in the first operating mode of the refrigeration device, the rotary shafts of the drive motors rotate in respective first directions of rotation and the working fluid circulates in the working circuit in a first direction of circulation, and in the second operating mode of the refrigeration device, at least one motor, in particular a motor to the shaft of which a turbine is coupled, is set in rotation in the opposite direction, meaning that its rotation shaft rotates in the opposite direction of rotation to the first direction of rotation,
the at least one compressor driven by a motor comprising a turbine that rotates conjointly with its shaft is of the centrifugal type, and in the second operating mode of the refrigeration device, the working fluid circulates in the working circuit in the first direction of circulation,
in the second operating mode of the refrigeration device, at least one drive motor separate from a motor set in rotation in the opposite direction is stopped or operates with a speed of rotation of between 1% and 60%, and preferably between 10 and 50%, in particular between 20 and 30%, of the maximum or nominal speed of said motor,
a flow of user fluid is made to circulate in the cooling exchanger by being pumped from a tank of user fluid, the user fluid that has undergone heat exchange with the cooling exchanger (8) being returned into the tank,
the method includes, simultaneously with and/or after the cleaning step, a step of purging the cooling exchanger with a flow of purge fluid injected into the cooling exchanger in order to sweep and evacuate from the cooling exchanger the impurities detached during the cleaning step,
the purging step comprises the sweeping of the exchanger with a neutral gas which is evacuated to a discharging zone,
the purging step comprises the sweeping of the exchanger with the user fluid.

The invention also relates to a low-temperature refrigeration device, that is to say for refrigeration at a temperature of between minus 100 degrees centigrade and minus 273 degrees centigrade, comprising a working circuit forming a loop and containing a working fluid, the working circuit forming a cycle that comprises, in series: a mechanism for compressing the working fluid, a mechanism for cooling the working fluid, a mechanism for expanding the working fluid, and a mechanism for heating the working fluid, the device comprising a cooling exchanger intended to extract heat at at least one member by heat exchange with the working fluid circulating in the working circuit, the refrigeration device comprising an electronic controller configured to control the refrigeration capacity of the refrigeration device and switch the refrigeration device into a first cooling operating mode of the cooling exchanger in order to cool a flow of userfluid made to circulate in this cooling exchanger, and a cleaning mode for cleaning away solidified impurities in the cooling exchanger, in the cleaning mode, the electronic controller being configured to lower the refrigeration capacity of the refrigeration device and decrease the cooling of the cooling exchanger compared with the first operating mode.

According to other possible particular features:
the compression mechanism comprises one or more compressors and at least one drive motor for rotating the compressor(s), the refrigeration capacity of the refrigeration device being variable and controlled by regulating the speed of rotation of the drive motor(s), the electronic controller being configured to set the speed of rotation of at least one of the drive motors in the second operating mode to a value of between 2% and 60%, and preferably between 10 and 50%, in particular between 20 and 30%, of the maximum or nominal speed of said motor,
the compression mechanism comprises a plurality of rotary compressors and at least two drive motors that each comprise a rotary drive shaft, the compressors being driven in rotation by the respective rotary shaft(s), the mechanism for expanding the working fluid comprising at least one rotary turbine that rotates conjointly with a shaft of one of the drive motors of at least one compressor,
in the second operating mode, the electronic controller is configured to stop at least one motor comprising a turbine that rotates conjointly with its shaft and to make at least one other drive motor of a compressor operate with a speed of rotation of between 1% and 60%, and preferably between 10 and 50%, in particular between 20 and 30%, of the maximum or nominal speed of said motor,
the device has a mechanical or electric or magnetic system for braking the stopped motor, braking and/or preventing the rotation of the shaft and/or compressor and/or turbine of said stopped motor,
in the first operating mode, the drive motors are configured to make their rotary shafts rotate in respective first directions of rotation, at least one motor comprising a turbine that rotates conjointly with its shaft is of the type having a reversible direction of rotation, the electronic controller being configured to make said motor rotate in the opposite direction of rotation to the first direction of rotation during the second operating mode of the refrigeration device,
in the second operating mode of the refrigeration device, the electronic controller is configured to stop at least one drive motor separate from a motor set in rotation in the opposite direction, or to limit the speed of rotation of this drive motor separate from a motor set in rotation in the opposite direction to a value of between 1% and 60%, and preferably between 10 and 50%, in particular between 20 and 30%, of the speed of rotation of said motor during the first operating mode.

The invention also relates to a system for refrigeration and/or liquefaction of a flow of user fluid, in particular natural gas, comprising a refrigeration device according to any one of the features above or below, the system comprising at least one tank of user fluid, and a duct for circulation of said flow of user fluid in the cooling exchanger.

The invention may also relate to any alternative device or method comprising any combination of the features above or below within the scope of the claims.

### BRIEF DESCRIPTION OF THE FIGURES

Further particular features and advantages will become apparent upon reading the following description, which is given with reference to the figures, in which:

The single FIGURE shows a schematic and partial view illustrating the structure and operation of an example of a device and a system that can implement the invention.

### DETAILED DESCRIPTION OF THE INVENTION

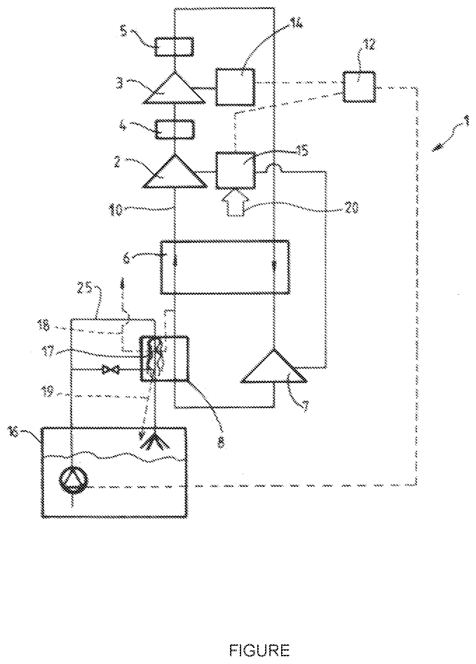

The cooling and/or liquefaction system in [FIG. 1] comprises a refrigeration device 1 that supplies cold (a cooling capacity) at a cooling exchanger 8. The system comprises a duct 25 for circulation of a flow of fluid to be cooled placed in heat exchange with this cooling exchanger 8. For example, the fluid is liquid natural gas pumped from a tank 16 (for example via a pump), then cooled (preferably outside the tank 16), then returned to the tank 16 (for example raining down in the gas phase of the tank 16). This makes it possible to cool or subcool the contents of the tank 16 and to limit the occurrence of vaporization. For example, the liquid from the tank 16 is subcooled below its saturation temperature (drop in its temperature of several degrees K, in particular 5 to 20K and in particular 14K) before being reinjected into the tank 16. In a variant, this refrigeration can be applied to the vaporization gas from the tank in order in particular to reliquefy it. This means that the refrigeration device 1 produces a cold capacity at the cooling exchanger 8.

The refrigeration device 1 comprises a working circuit 10 (preferably closed) forming a circulation loop. This working circuit 10 contains a working fluid (helium, nitrogen, neon, hydrogen or another appropriate gas or mixture, for example helium and argon or helium and nitrogen or helium and neon or helium and nitrogen and neon).

The working circuit 10 forms a cycle comprising, in series: a mechanism 2, 3 for compressing the working fluid, a mechanism 6 for cooling the working fluid, a mechanism 7 for expanding the working fluid, and a mechanism 6, 8 for heating the working fluid.

The device 1 comprises a cooling heat exchanger 8 intended to extract heat at at least one member 25 by heat exchange with the working fluid circulating in the working circuit 10.

The mechanisms for cooling and heating the working fluid conventionally comprise a common heat exchanger 6 through which the working fluid passes in countercurrent in two separate passage portions of the working circuit 10 depending on whether it is cooled or heated.

The cooling heat exchanger 8 is situated for example between the expansion mechanism 7 and the common heat exchanger 6. As illustrated, the cooling heat exchanger 8 may be a heat exchanger separate from the common heat exchanger 6. However, in a variant, this cooling heat exchanger 8 could be made up of a portion of the common heat exchanger 6 (meaning that the two exchangers 6, 8 can be in one piece, i.e. may have separate fluid circuits that share one and the same exchange structure).

Thus, the working fluid which leaves the compression mechanism 2, 3 in a relatively hot state is cooled in the common heat exchanger 6 before entering the expansion mechanism 7. The working fluid which leaves the expansion mechanism 7 and the cooling heat exchanger 8 in a relatively cold state is, for its part, heated in the common heat exchanger 6 before returning into the compression mechanism 2, 3 in order to start a new cycle.

Conventionally, in a normal operating mode, referred to below as “first operating mode”, the working gas undergoes the cycle of compression, cooling, expansion and heating and produces cold at the cooling exchanger 8. Generally, an equal or substantially equal mass flow rate circulates in the two passage portions in the common heat exchanger 6.

As illustrated, in the normal operating mode, a flow of fluid (liquefied natural gas for example) can be cooled in the cooling exchanger 8. In the event that this fluid contains impurities (carbon dioxide or the like) that are likely to solidify as they are cooled, a blockage 17 or an obstruction may arise in the cooling exchanger 8.

This blockage may be eliminated by a cleaning step carried out by the refrigeration device 1 itself by adopting a second operation mode in which the working gas still circulates in the working circuit 10, as described above, but in which the cooling of the cooling exchanger 8 is decreased compared with the first operating mode.

For example, the refrigeration device 1 periodically effects zero cooling or effects heating of the cooling exchanger 8.

During this cleaning, a flow of user fluid can be made to circulate in the cooling exchanger 8 in order to carry along the impurities heated by the latter. The flow of user fluid may in particular be heated during this second operating mode.

The compression mechanism 2, 3 may comprise one or more compressors and at least one drive motor 14, 15 for rotating the compressor(s) 2, 3. In addition, preferably, the refrigeration capacity of the device is variable and can be controlled by regulating the speed of rotation of the drive motor(s) 14, 15 (cycle speed). Preferably, the cold capacity produced by the device 1 can be adapted by 0 to 100% of a nominal or maximum capacity by changing the speed of rotation of the motor(s) 14, 15 between a zero speed of rotation and a maximum or nominal speed. Such an architecture makes it possible to maintain a high performance level over a wide operating range (for example 97% of nominal performance at 50% of the nominal cold capacity).

For example, in the second operating mode, the speed of rotation of at least one of the drive motors 14, 15 is reduced to a value of between 1% and 60%, and preferably between 10 and 50%, in particular between 20 and 30%, of the speed of rotation of said motor 14, 15 during the first cooling operating mode. For example, this reduced speed of rotation corresponds to between 1% and 60%, and preferably between 10 and 50%, in particular between 20 and 30%, of the nominal or maximum speed of rotation of said motor 14, 15.

In this configuration, the refrigeration capacity produced at the cooling exchanger 8 is decreased or eliminated (or heat is produced there). In this way, the heating exchanger 8 will heat up, causing the solidified impurities to melt and then vaporize. This heating, associated optionally with a flow of user fluid in the cooling heat exchanger 8 will carry these impurities out of the exchanger 8, for example toward the tank 16 of user fluid.

In the nonlimiting example depicted, the refrigeration device 1 comprises two compressors 2, 3 in series that are driven respectively by two separate motors 14, 15 and a turbine 7 coupled to the drive shaft of one 15 of the two motors.

This means that a first motor 14 drives only one compressor 3 (motor-compressor) while the other motor 15 drives a compressor 2 and is coupled to a turbine 7 (motor-turbocompressor).

For example, in the second operating mode of the refrigeration device 1, the motor 15 having the drive shaft to which a turbine 7 is coupled is stopped and the other motor 14, which drives only a compressor 3, operates with a speed of rotation of between 1% and 60%, and preferably between 10 and 50%, in particular between 20 and 30%, of the maximum speed of rotation or of the nominal speed of the motor. The nominal speed or maximum speed of a motor means the maximum speed that the motor can produce in the case of a maximum refrigeration capacity. This maximum or nominal speed is the maximum speed advised for the operation of the refrigeration device 1 and may, if necessary, be lower than the maximum speed that the motor can intrinsically achieve.

In this configuration, the turbine 7 and the compressor 2 that are coupled to the drive shaft of the stopped motor 15 can freewheel.

As before, operation of the other motor 14 at reduced speed will make the working fluid circulate in the working circuit 10 with low efficiency. The freewheeling turbine 7 and compressor 2 will also add pressure drops in the working circuit 10 of the working gas. This will increase the relative heating at the cooling exchanger 8 in order to evacuate the impurities, without increasing the power consumption of the device 1 that has already been reduced.

To further increase this heating and the rapidity of cleaning away of the impurities, an additional pressure drop can be added in this operating mode. For example, the stopped motor 15 is braked. For example, the rotation of its shaft and/or of the corresponding compressor 2 and/or turbine 7 can be braked or prevented. This braking 20 or prevention may be mechanical via a mobile and/or electric and/or magnetic stop. For example, the motor(s) are electric motors, in particular of the synchronous type. The braking of the motor can be carried out by providing a braking resistor in its control circuit for this operating mode. Similarly, such an electric motor may have a three-phase circuit diagram which may be short-circuited temporarily to ensure this braking. The motor 15 may in particular be reversible and the braking may be obtained by switching it to its reverse generator mode in which, rather than producing a torque, it will produce a current and brake its drive shaft.

These braking modes may be available on the control circuits (variators) of such electric motors. Thus, simple software control makes it possible to bring about these braking modes without modifying the pre-existing structure of the motor.

In yet another embodiment variant, in the second operating mode, at least one motor 15, for example a motor comprising a turbine 7 that rotates conjointly with its shaft, is set in rotation in the opposite direction.

This means that, in the first operating mode of the refrigeration device 1, the rotary shafts of the drive motors 14, 15 rotate in respective first directions of rotation and the working fluid circulates in the working circuit 10 in a first direction of circulation, and in the second operating mode of the refrigeration device 1, at least one motor 15, preferably to the shaft of which a turbine 7 is coupled, is set in rotation in the opposite direction, meaning that its rotation shaft rotates in the opposite direction of rotation to the first direction of rotation.

The working fluid will continue to circulate in the first direction of circulation in the working circuit 10 but the opposite rotation of the turbine 7 in particular (which is not optimized for this direction) will, rather than extract mechanical work from the working gas (expansion), will supply mechanical work thereto and therefore heat it up. This operates in particular using turbine technology with turbines of the centripetal type. Also preferably, the compressor(s) are of the centrifugal type.

While this motor 15 is set in rotation in the opposite direction (in reverse), the other motor 14 (or the other motors if there are several) can be stopped, but in particular so as to freewheel, and preferably the other motor 14 (or the other motors) is/are made to operate with a reduced speed of rotation. For example, this other motor 14 (or at least one of the other motors) is set in rotation at a speed of between 1% and 60%, and preferably between 10 and 50%, in particular between 20 and 30%, of the maximum or nominal speed of rotation of said motor 14.

This reduced speed of the motor(s) increases the efficiency of the heating and allows a quicker and more efficient restart of the refrigeration device in the first cooling operating mode.

Preferably, the motor(s) 14 set in rotation in the opposite direction is/are set in rotation at a reduced speed, for example at a speed of between 1% and 60%, and preferably between 10 and 50%, in particular between 20 and 30%, of the maximum or nominal speed of rotation of said motor.

However, in one possible variant, the speed of rotation in the opposite direction could be higher and could reach the nominal or maximum speed of the motor.

The device may comprise at least one electronic controller 12 connected to all or part of the members of the system (motors, valves, pump, etc.). The electronic controller 12 may comprise a microprocessor or a computer and may be configured to dynamically control all or part of the members of the system and in particular to bring about the above-described operating modes (automatically and/or in response to a command, in particular by a user).

For example, the switching into the second operating mode of the refrigeration device 1 to effect the cleaning of the cooling exchanger 8 may be commanded by a user and/or in response to the detection of an impurity blockage in the cooling exchanger 8 (pressure sensor or the like in the circuit).

Moreover, the electronic controller 12 may be configured (programmed or commanded) to dynamically control the heating of the cooling exchanger 8 in the second operating mode. For example, this control (the relative heating capacity with respect to the first operating mode) may depend on the speed of the rise in temperature of the common heat exchanger 6 according to a given profile and/or to keep the speed of the rise in temperature of the common heat exchanger 6 below a given threshold. This may make it possible to prevent the common heat 6 exchanger and/or the cooling exchanger 8 from heating up too quickly, this being advantageous in the case for example of an exchanger having an aluminum plate.

In the example depicted, the refrigeration device 1 comprises two compressors 2, 3 that form two compression stages and an expansion turbine 7. This means that the compression mechanism comprises two compressors 2, 3 in series, preferably of the centrifugal type, and the expansion mechanism comprises a single turbine 7, preferably a centripetal turbine. Of course, any other number and arrangement of the compressor(s) and turbine may be envisioned, for example three compressors in series and one turbine or three compressors and two or three turbines, or two compressors and two turbines, etc.

In the example illustrated, a cooling exchanger 4, 5 is provided at the outlet of each compressor 2, 3 (for example cooling by heat exchange with water at ambient temperature or any other cooling agent or fluid).

This makes it possible to realize isentropic or isothermal or substantially isothermal compression. Of course, any other arrangement may be envisioned (for example no cooling exchanger 4, 5 having one or more compression stages). Similarly, a heating exchanger may or may not be provided at the outlet of all or part of the expansion turbines 7 to realize isentropic or isothermal expansion. Also preferably, the heating and cooling of the working fluid are preferably isobaric, without this being limiting.

For example, the device 1 comprises two high-speed motors 14, 15 (for example 10 000 revolutions per minute or several tens of thousands of revolutions per minute) for respectively driving the compression stages 2, 3. The turbine 7 may be coupled to the motor 2 of one of the compression stages 2, 3, meaning that the device may have a turbine 8 forming the expansion mechanism which is coupled to the drive motor 2 of a compression stage 2 (in particular the first).

Thus, the power of the turbine(s) 7 can advantageously be recovered and used to reduce the consumption of the motor(s). Thus, by increasing the speed of the motors (and thus the flow rate in the cycle of the working gas), the refrigeration capacity produced and thus the electrical consumption of the liquefier are increased (and vice versa). The compressors 2, 3 and turbine(s) 7 are preferably coupled directly to an output shaft of the motor in question (without a geared movement transmission mechanism).

The output shafts of the motors are preferably mounted on bearings of the magnetic type or of the dynamic gas type. The bearings are used to support the compressors and the turbines.

Moreover, all or part of the device, in particular the cold members thereof, can be accommodated in a thermally insulated sealed casing (in particular a vacuum chamber containing the common countercurrent heat exchanger).

To further improve the efficiency and rapidity of the process, a purge 18 of the cooling exchanger 8 with a flow of purge fluid injected into the cooling exchanger 8 in order to sweep and evacuate from the cooling exchanger 8 the impurities detached during the cleaning step can be provided simultaneously with and/or after the cleaning step.

For example, a circuit 18 of neutral gas or the like (nitrogen for example) may be provided to purge the heated impurities. This purge may, if necessary, replace making the flow of user fluid circulate during heating. The mixture obtained can be evacuated to a discharging zone (to the atmosphere for example).

Alternatively, this purge 18 may be realized with a flow of user fluid. For example, a user fluid fraction is withdrawn from the circulation duct 12 (via a bypass provided with a valve for example). The purge user fluid can vaporize in the cooling exchanger 8 and detach the impurities. The mixture obtained can be sent back to the outside or a collection zone and can, in particular, be reinjected into the tank 16 of user fluid.

The invention may apply to a method for cooling and/or liquefying another fluid or mixture, in particular hydrogen.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context dearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A method for refrigeration and/or liquefaction of a flow of user fluid, said method comprising the steps of:
providing a cooling and/or liquefaction system that comprises a low-temperature refrigeration at a temperature of between minus 100 degrees centigrade and minus 273 degrees centigrade, the refrigeration device comprising a working circuit forming a loop and containing a working fluid, the working circuit forming a cycle that comprises, in series: a mechanism for compressing the working fluid, a mechanism for cooling the working fluid, a mechanism for expanding the working fluid, and a mechanism for heating the working fluid, the refrigeration device comprising a cooling exchanger intended to extract heat from the flow of user fluid by heat exchange with the working fluid circulating in the working circuit, the system comprising a duct for the circulation of said flow of user fluid in the cooling exchange;
operating the refrigeration device in a first operating mode of the cooling exchanger while a flow of user fluid is made to circulate in the cooling exchanger; and
after performance of said step of operating the refrigeration device in a first cooling operating mode, cleaning away solidified impurities in the cooling exchanger during a cleaning step during which the refrigeration device is operated in a second operating mode in which the working gas circulates in the working circuit but in which the cooling of the cooling exchanger is decreased compared with the first operating mode, wherein:
the compression mechanism comprises a plurality of rotary compressors and at least two drive motors that each comprise a rotary drive shaft;
the compressors are driven in rotation by the respective rotary shaft(s);
the mechanism for expanding the working fluid comprises at least one rotary turbine that rotates conjointly with a shaft of one of the drive motors of at least one compressor; and
in the first operating mode, the rotary shafts of the drive motors rotate in respective first directions of rotation and the working fluid circulates in the working circuit in a first direction of circulation, and in the second operating mode, at least one motor to the shaft of which a turbine is coupled, is set in rotation in the opposite direction such that its rotation shaft rotates in an opposite direction of rotation to the first direction of rotation.

17. The method of claim 16, wherein, during the cleaning step, the refrigeration device effects zero cooling of the cooling exchanger or effects heating of the cooling exchanger.

18. The method of claim 16, wherein, during the cleaning step, a flow of user fluid is made to circulate in the cooling exchanger and is heated thereby.

19. The method of claim 16, wherein the compression mechanism comprises one or more compressors and at least one drive motor for rotating the compressor(s), the refrigeration capacity of the refrigeration device is variable and is controlled by regulating a speed of rotation of the drive motor(s), and in that, in the second operating mode, the speed of rotation of at least one of the drive motors is between 1% and 60%, and preferably between 10 and 50%, in particular between 20 and 30%, of the maximum or nominal speed of rotation of said motor.

20. The method of claim 19, wherein, in the second operating mode of the refrigeration device, at least one motor comprising a turbine that rotates conjointly with its shaft is stopped, and in that at least one other drive motor of a compressor operates with a speed of rotation of between 1% and 60% of a maximum or nominal speed of said motor.

21. The method of claim 19, wherein, in the second operating mode of the refrigeration device, at least one motor comprising a turbine that rotates conjointly with its shaft is stopped, and in that at least one other drive motor of a compressor operates with a speed of rotation of between 10 and 50% of a maximum or nominal speed of said motor.

22. The method of claim 19, wherein, in the second operating mode of the refrigeration device, at least one motor comprising a turbine that rotates conjointly with its shaft is stopped, and in that at least one other drive motor of a compressor operates with a speed of rotation of between 20 and 30% of a maximum or nominal speed of said motor.

23. The method of claim 19, wherein the at least one stopped motor is braked, such that the rotation of the corresponding shaft and/or compressor and/or turbine is braked or prevented.

24. The method of claim 16, wherein the at least one compressor driven by a motor comprising a turbine that rotates conjointly with its shaft is of the centrifugal type, and in that, in the second operating mode of the refrigeration device, the working fluid circulates in the working circuit in the first direction of circulation.

25. The method of claim 16, wherein, in the second operating mode of the refrigeration device, at least one drive motor separate from a motor set in rotation in the opposite direction is stopped or operates with a speed of rotation of between 1% and 60%, and preferably between 10 and 50%, in particular between 20 and 30%, of the maximum or nominal speed of said motor.

26. The method of claim 16, wherein a flow of user fluid is made to circulate in the cooling exchanger by being pumped from a tank of user fluid, and in that the user fluid that has undergone heat exchange with the cooling exchanger is returned into the tank.

27. The method of claim 16, wherein the user fluid is natural gas.

28. A low-temperature refrigeration device for refrigeration at a temperature of between minus 100 degrees centigrade and minus 273 degrees centigrade, comprising:
a working circuit forming a loop and containing a working fluid, the working circuit forming a cycle that comprises, in series: a mechanism for compressing the working fluid, a mechanism for cooling the working fluid, a mechanism for expanding the working fluid, and a mechanism for heating the working fluid;
a cooling exchanger intended to extract heat at at least one member by heat exchange with the working fluid circulating in the working circuit; and
an electronic controller configured to control a refrigeration capacity of the refrigeration device and switch the refrigeration device into a first cooling operating mode of the cooling exchanger in order to cool a flow of user fluid that circulates in the cooling exchanger, and a cleaning mode for cleaning away solidified impurities in the cooling exchanger, wherein:
in the cleaning mode, the electronic controller is configured to lower the refrigeration capacity of the refrigeration device and decrease the cooling of the cooling exchanger compared with the first operating mode;
the compression mechanism comprises a plurality of rotary compressors and at least two drive motors that each comprise a rotary drive shaft;
the compressors are driven in rotation by the respective rotary shaft(s);
the mechanism for expanding the working fluid comprises at least one rotary turbine that rotates conjointly with a shaft of one of the drive motors of at least one compressor; and
in the first operating mode, the drive motors are configured to make their rotary shafts rotate in respective first directions of rotation, at least one motor comprising a turbine that rotates conjointly with its shaft is of the type having a reversible direction of rotation, and in that the electronic controller is configured to make said motor rotate in the opposite direction of rotation to the first direction of rotation during the second operating mode of the refrigeration device.

29. The device of claim 28, wherein:
the compression mechanism comprises one or more compressors and at least one drive motor for rotating the compressor(s);
the refrigeration capacity of the refrigeration device is variable and controlled by regulating a speed of rotation of the drive motor(s); and
the electronic controller is configured to set the speed of rotation of at least one of the drive motors in the second operating mode to a value of between 2% and 60% of a maximum or nominal speed of said motor.

30. The device of claim 28, wherein, in the second operating mode, the electronic controller is configured to stop at least one motor comprising a turbine that rotates conjointly with its shaft and to make at least one other drive motor of a compressor operate with a speed of rotation of between 1% and 60% of a maximum or nominal speed of said motor.

31. The device of claim 28, further comprising a mechanical or electric or magnetic system for braking the stopped motor so as to brake and/or prevent rotation of the shaft and/or compressor and/or turbine of said stopped motor.

32. The device of claim 28, wherein, in the second operating mode of the refrigeration device, the electronic controller is configured to stop at least one drive motor separate from a motor set in rotation in the opposite direction, or to limit the speed of rotation of this drive motor separate from a motor set in rotation in the opposite direction to a value of between 1% and 60% of the speed of rotation of said motor during the first operating mode.

33. A system for refrigeration and/or liquefaction of a flow of user fluid, comprising a refrigeration device of claim 28, a system comprising at least one tank of user fluid, and a duct for circulation of said flow of user fluid in the cooling exchanger.

34. The system of claim 33, wherein the user fluid is natural gas.
